(19) United States
(12) Patent Application Publication
(10) Pub. No.: US 2006/0141870 A1
(43) Pub. Date: Jun. 29, 2006

(54) Environmentally sealed chip socket

(75) Inventors: Donald W. Milbrand JR., Bristol, NH (US); Thomas S. Cohen, New Boston, NH (US)

Correspondence Address: Edmund J. Walsh;Wolf, Greenfield & Sacks, P.C., 600 Atlantic Avenue, Boston, MA, 02210-2206, US

(73) Assignee: Teradyne, Inc., Boston, MA (US)

(21) Appl. No.: 11/059,492

(22) Filed: Feb. 8, 2005

Related U.S. Application Data
(60) Provisional application No. 60/639,047, filed on Dec. 23, 2004.

(51) Int. Cl. H01R 13/514

(52) U.S. Cl. 439/701

(57) ABSTRACT

A chip socket with one or more seals protecting the contact members. The seals are formed in a multi-step molding process. In a first step, an insulative housing is formed with grooves in the surface. In the second step, a seal material is molded into the grooves with a portion extending above the surface of the insulative housing. In use, surfaces of the chip socket are pressed against a semiconductor chip or a circuit board. When pressed together, the components of the connector system form seals that protect contact members from environmental conditions. The seals allow reliable electrical connections to be made with reduced force per contact. Greater flexibility in designing the contact members is therefore provided contact members having a low spring force and a relatively large deflection range, thereby accommodating a less stringent coplanarity requirement for the chip and circuit board.

This application claims priority under 35 U.S.C. § 119(e) to U.S. Provisional Application Ser. No. 60/639,047, entitled “Environmentally Sealed Chip Socket,” filed on Dec. 23, 2004, which is herein incorporated by reference in its entirety.

### BACKGROUND OF INVENTION

1. Field of Invention

This invention relates generally to electrical connectors and more specifically to chip sockets.

2. Discussion of Related Art

Electrical connectors are used in many portions of electronic systems. Electrical connectors allow the system to be easily manufactured from subassemblies. The connectors interconnect the subassemblies without the need for soldering or other forms of permanent or semi-permanent attachment that can be expensive or time consuming to manufacture.

Connectors also allow the subassemblies to be easily disassembled. This feature makes the electronic system easier to repair, maintain or upgrade.

Electrical connectors are often installed on printed circuit boards. The connectors may be used to join conducting traces on one printed circuit board to the conducting traces on another printed circuit board. Such connectors are sometimes referred to as Level III connectors.

Connectors are also used to attach components, such as integrated circuit chips in packaged or unpackaged form, to printed circuit boards. Connectors used for this purpose are sometimes referred to as chip sockets or Level II connectors. Connectors are used to connect other types of components at other “levels” of the system.

Regardless of the specific application of the connector, it is desirable that the connector form a reliable electrical connection over the useful life of the product in which it may be installed.

It would be desirable to provide an improved electrical connector and would be particularly desirable to provide an improved electrical connector suitable for use as a chip socket.

### SUMMARY OF INVENTION

In one aspect, the invention relates to an electrical connector having a housing and a plurality of conductive contact elements having a first portion and a second portion, with the first portion disposed in the housing and the second portion exposed in a surface of the housing. The connector includes a seal having a first portion and a second portion, with the first portion positioned in the housing and the second portion exposed in a surface of the housing. The seal outlines an area and the second portion of at least one of the plurality of conductive contact elements is positioned within this area.

In another aspect, the invention relates to an electrical connector comprising a housing and a plurality of conductive contact elements having a first portion and a second portion. The first portion is disposed in the housing and the second portion exposed in a surface of the housing. The connector includes a plurality of compliant structures, each having a first portion and a second portion, with the first portion positioned in the housing and the second portion exposed in the surface. Each of the compliant structures outlines an area of the surface and the second portion of at least one of the plurality of conductive contact elements is positioned within the area.

In a further aspect, the invention relates to a method of manufacturing an electrical connector. The method involves providing a plurality of conductive members; forming a housing of a first type material with a plurality of locations adapted to receive a conduction member of the plurality of conductive members, the housing having a surface with at least a portion of each of the conductive members exposed through the surface; and affixing a compliant member to the housing to encircle at least one of the locations, with a portion of the compliant member extending above the surface.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a sketch of a connector system according to the invention;

FIG. 2 is a side view of the connector system of FIG. 1;

FIG. 3 is an enlarged cross-sectional view of a portion of the connector system of FIG. 1; and

FIG. 4 is a cross sectional view of an alternative embodiment of a connector system according to the invention.

### DETAILED DESCRIPTION

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

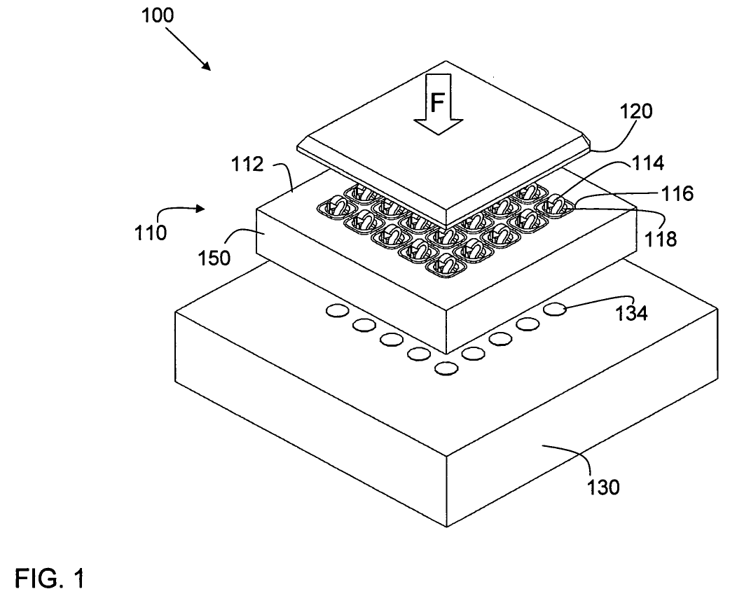

The invention is here illustrated by a connector system 100 as shown in FIG. 1. In this example, the connector system includes a chip socket 110 designed to provide a separable electrical connection between a chip 120 and a substrate, such as a circuit board 130.

FIG. 1 illustrates a relatively small semiconductor chip 120 having a small number of pads that require connection to circuit board 130. Such a configuration is shown for simplicity of illustration. The invention may be particularly useful in connection with a relatively large chip, such as a computer processor chip, which may have over one hundred I/O pads for which connections are made to a circuit board 130.

In use, a force F is applied to chip 120. The force presses chip 120 into chip socket 110. The force F also presses chip socket 110 against circuit board 130. Force F may be generated by a retaining structure (not shown) attached to circuit board 130. Such retaining structures are conventionally used with chip sockets and include levers, latches, camming surfaces or other structures that may hold chip socket 110 and chip 120 against circuit board 130. However, any suitable retaining structure may be used to generate the force F.

Chip socket 110 includes a housing 150. In the described embodiment, housing 150 is an insulative material. In one embodiment, housing 150 is formed from a therma-plastic material so that it may be readily molded into a desired shape. Materials conventionally used to form the housing of electrical connectors, whether now known or hereafter developed, may be used to form housing 150. Examples of suitable materials are LCP and nylon.

Compliant members 114 extend from a surface 112 of chip socket 110. For simplicity, only one of the compliant members 114 is numbered. The compliant members may be identical. Compliant member 114 may be formed from any suitable compliant conductive material. Materials traditionally used for electrical contacts in electrical connectors may be used. In the embodiments shown herein, springy metals are used. Examples of suitable materials are copper alloys and phosphor bronze. Compliant member 114 may have a protective coating over all or a portion of its surface. The coating may be formed from a relatively inert metal that resists oxidation, such as gold, nickel or tin.

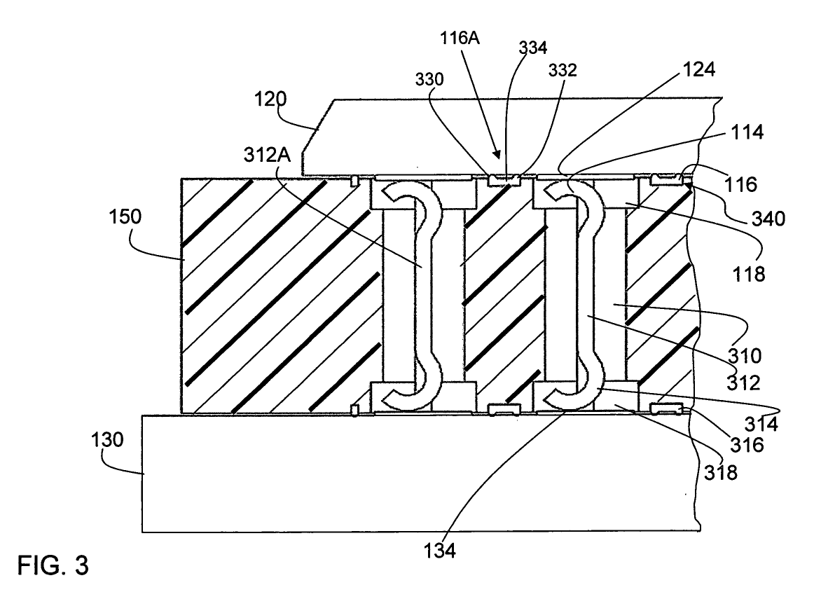

When chip 120 is pressed against chip socket 110, compliant members 114 press against conductive structures on chip 120. In this way, an electrical connection may be formed between conductors and chip 120 and the conductors within chip socket 110. Similar compliant members (See, e.g., 314, FIG. 3) extend from an opposing surface of the chip socket 110 and are electrically connected to compliant members 114. The compliant members extend from the opposing surface of housing 150 are positioned to engage conducting pads 134 on the surface of circuit board 130. Force F presses the compliant members 314 against pads 134, thereby completing a conductive path between chip 120 and circuit board 130.

In the illustrated embodiment, each of the compliant members 114 is positioned within a recess 118. As chip 120 is pressed against chip socket 110, compliant member 114 retracts into recess 118. Similar recesses (see, e.g., 318, FIG. 3) are provided on the lower surface of chip socket 110 to receive compliant members 314.

Recess 118 is surrounded by a seal 116. Seal 116 is formed from a low durometer material such as is conventionally used in forming seals or gaskets. Preferably, seal 116 is formed from a material that is relatively impervious to oxygen and other gases from the ambient environment. In some embodiments, seal 116 is formed from a curable material, such a silicone, that may be molded in place. Examples of other suitable materials for forming seal 116 are rubber and rubberized plastic.

As shown, seal 116 extends above surface 112. As force F presses chip 120 against chip socket 110, seal 116 presses against the lower surface of chip 120. Because seal 116 is made of a compliant material, it conforms to the shape of chip 120. Preferably, the force F is sufficient to form an environmental seal between chip socket 110 and chip 120.

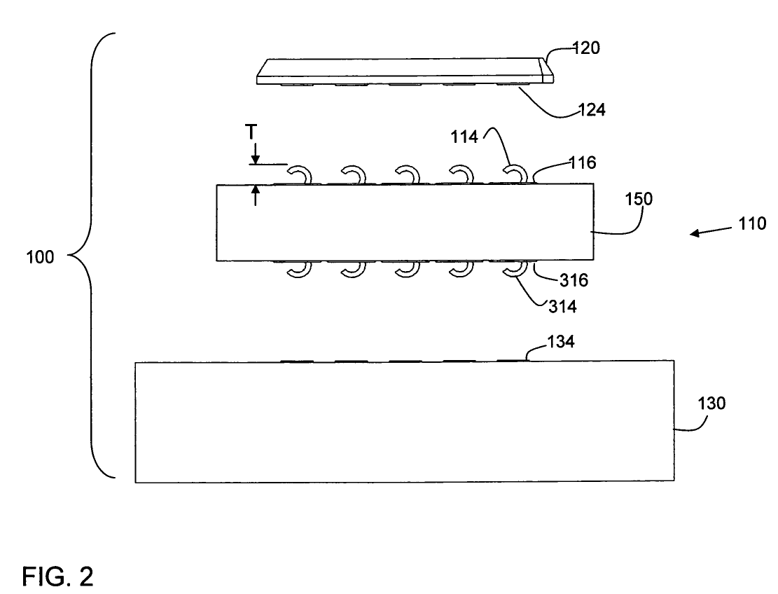

FIG. 2 shows a side view connector system 100. In this view, it may be seen that the illustrated embodiment of chip socket 110 includes symmetrical upper and lower surfaces. The upper surface includes compliant members 114 facing chip 120. The lower surface includes compliant members 314 facing circuit board 130. Each compliant member 114 is electrically connected to a compliant member 314.

Each of the compliant members 114 and 314 makes contact with a conducting pad. Compliant members 114 on the upper surface of chip socket 110 may contact with pads 124 on chip 120. Compliant members 314 on the lower surface of chip socket 110 make contact with pads 134 on circuit board 130. Pads 124 on chip 120 may be electrically connected to circuitry within chip 120. Likewise, pads 134 may be electrically connected to traces or other circuit components within circuit board 130. In this way, chip socket 110 completes an electrical connection between circuitry inside chip 120 and circuit board 130.

In the exploded view of FIG. 2, the compliant members such as 114 and 314 are shown extended. Compliant members 114 extend a distance T above the surface of housing 150. When chip 120 is pressed against chip socket 110, compliant members 114 may be compressed by a distance T. Distance T represents the “travel” of the compliant member.

Having a large amount of travel ensures that compliant members 114 will make contact with pads 124 even if there are variations in the manufacture of the components. For example, variations that are the result of manufacturing tolerances may result in some compliant members extending above the surface of housing 150 by less then the amount illustrated. However, where T is sufficiently large, routine manufacturing variations will not preclude any of the compliant members from engaging with a pad on chip 120. In some embodiments, the distance T may be between approximately 0.1 mm and 1 mm. In the embodiments pictured herein, the distance T is on the order of 0.5 mm.

Providing a large amount of travel enables a large working deflection. The working deflection represents the difference between the minimum and maximum deflection of the compliant members 114 that may result because of manufacturing tolerances of the components. In the embodiment illustrated, the maximum travel T, taking into account manufacturing variations, is the working deflection.

A traditional connector is designed so that the contact force is sufficient to form a reliable electrical connection. Sufficient contact force is desired to prevent gases from the ambient environment from reaching and interacting with the metals of the contact members in the contact region. Gases including oxygen, chlorine and sulfur are often present in the environments where printed circuit boards are used or manufactured and can interact with the contacts to form an oxide coating over the contacts. Because metal oxides are generally nonconductive, formation of an oxide in the contact region may increase the resistance of the contact or decrease the reliability of the connection between a compliant member 114 and pad 124. To avoid the formation of oxide in the contact region, traditional connectors are often designed to provide approximately 50 grams of force for each contact.

If 50 grams is the minimum acceptable contact force, this amount of force must be generated at the minimum deflection of compliant member 114. At the maximum deflection of compliant member 114, the contact force will be greater. The amount by which the contact force will increase over the minimum acceptable contact force will be related to the working deflection.

The maximum possible contact force, multiplied by the total number of contacts, indicates the minimum value for the force F that should be applied to hold a chip 120 in socket 110. Using conventional designs to provide a contact force of approximately 50 grams of force per contact while simultaneously providing relatively large working deflection leads to one of several problems. One possibility is that the total force F becomes unworkably large. Another possible negative result is that the compliant members may be too large for readily interfacing to the small contact areas traditionally available on an integrated circuit chip. Here, these problems are avoided by using an environmental seal to reduce the required contact force, allowing connectors to be made with a relatively large working deflection in a relatively small space.

FIG. 3 illustrates how seals 116 may be used to increase the integrity of the electrical connections between chip socket 110 and a chip 120. A similar seal 316 is used to increase the integrity of electrical connections between a chip socket 110 and circuit board 130.

In the configuration illustrated in FIG. 3, compliant member 114 is shown pressed into recess 118 by chip 120. Chip 120 contacts seals 116 in the upper surface of housing 150. Seals 116 provide sufficient compliance so that a relatively gas impervious seal is formed between seal 116 and chip 120. Because the seal 116 encircles recess 118, seal 116 in conjunction with the lower surface of chip 120 seals compliant member 114 within recess 118. Oxygen and other gases are prevented from reaching compliant member 114, thereby substantially reducing the rate at which oxide forms on compliant member 114 or pad 124. When the mating interface between compliant member 114 and pad 124 is sealed within recess 118, the amount of force needed to ensure a reliable connection is decreased. In some embodiments, the amount of force is less than about twenty five grams per contact. In other embodiments forces of 15-25 grams per contact may be used.

Seal 316 in the lower surface of housing 150 forms a similar seal between housing 150 and circuit board 130. Seal 316 seals compliant member 314 within recess 318. The required contact force between compliant member 314 and pad 134 is therefore reduced.

FIG. 3 also illustrates details of a possible method of manufacturing chip socket 100. Housing 150 may be molded from plastic or other insulative material. Housing 150 may be molded with recesses such as 118 and 318 in each surface. A passage 310 may be formed, connecting the recesses. The recesses 118 are formed to align with the pads 124 on the lower surface of chip 120. Recesses 318 on the lower surface are likewise centered around pads 134. Pads 134 may be, but do not need to be, aligned with pads 124.

Contact members 312 are inserted into the passage 310. Opposing ends of the contact member 312 may be formed into compliant portion 114 and 314. Contact member 312 may be secured within passage 3.10 according to any suitable means. For example, contact member 312 may be held in place through an interference fit with the walls of passage 310. Alternatively, barbs or other retaining structures formed in contact 310 may engage housing 150 to hold contact member 312 in place.

FIG. 3 shows that each seal 116 and 316 has a portion positioned in a recess, such as grooves 340, of a surface of housing 150. Seal 116 and 316 may be held in place in any suitable manner. Seals 116 and 316 may be held in place through an interference fit with housing 150. Alternatively, seals such as 116 and 316 may be glued or otherwise adhered to a surface of housing 150. FIG. 1 shows that each seal 116 has a raised portion encircling a compliant member 114.

The seal surrounding each compliant member could be formed from a separate structure. Alternatively, some or all of the seals surrounding compliant members may be formed from a single piece of compliant material. For example, seal portion 116A includes a raised portion 330 and a raised portion 332. Raised portions 330 and 332 are joined by a bridge 334 of material. Raised portion 330 forms a portion of the seal encircling contact member 312A. Raised portion 332 forms a portion of the seal encircling contact member 312. In this embodiment, bridge portion 334 does not contribute to forming a seal around either contact member 312 or 312A. However, bridge portion 334 may facilitate forming raised portions 330 and 332 in a molding operation. Placing bridging material between the seals encircling the individual contact members facilitates the flow of material during molding and reduces the number of material inlets required for the molding operation.

Seals 116 may be formed in housing 150 in a multi-step molding process. In a first step, housing 150 may be molded with grooves 340 formed in the surfaces in positions where seal members should be placed in the finished socket. In a second molding step, seal material may be deposited in the grooves 340.

Any suitable method of forming housing 150 may be used. For example, housing 150 may be molded in a two barrel molding machine. In a two barrel molding machine, the insulative material forming housing 150 is injected while inserts are positioned where grooves 340 are to be formed. Once the insulative material forming housing 150 sets, the inserts occupying grooves 340 are removed. Those inserts may, for example, be attached to camming mechanisms that slide the members in and out of the cavity as desired. With the inserts removed, a second type of material may then be injected into the voids formed by removing those inserts.

As an alternative, a two cavity molding operation may be used. The first cavity may have a mold shaped to conform to the profile of insulative housing 150 alone. Once the insulative housing 150 is formed in this cavity, the work piece may be moved to a second cavity with a mold having a contour conforming to the shape of insulative housing 150 and seals 116 and 316 combined. When the work piece is placed in this mold, voids are left where the seals 116 and 316 are to be formed. Seal material is then inserted in these voids.

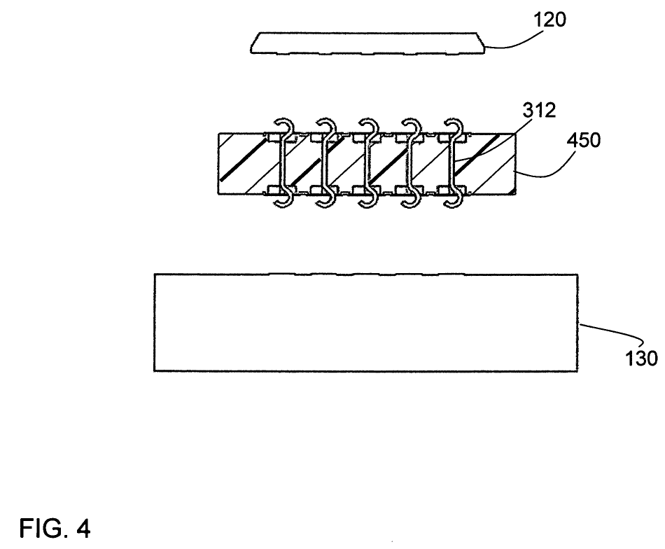

Turning to FIG. 4, an alternative embodiment of chip socket 110 is shown. Here, chip socket 110 is formed with a housing 450. Housing 450 is formed without passages 310 to receive contact members. In this embodiment, housing 450 is insert molded around the contact members 312. In an insert molding operation, the contact members may be formed attached to a lead frame that holds the contact members in the desired positions. Once the housing is molded around the contact members, the lead frame can be cut away.

Having thus described several aspects of at least one embodiment of this invention, it is to be appreciated various alterations, modifications, and improvements will readily occur to those skilled in the art.

For example, each contact element is pictured as being formed from a single piece of metal that is bent to form contact portions on each end. Contact elements need not be formed in this way. Each contact element may be formed from multiple pieces of metal that are electrically coupled to each other. Each contact element may alternatively be formed from a combination of metal pieces and other conductive components that are coupled to form a conducting path.

Likewise, the number of pieces from which other components are constructed may be varied. For example, each seal member is shown made from a single piece. However, seal members may be formed from multiple segments.

As a further variation, surfaces of the chip carrier are shown to be planar. The invention is not limited to use in planar structures. Surfaces may be curved or may have projections or other non-planar portions. In use, the portions of the chip carrier having seals around contact elements may be pressed towards other structures that conform generally to the their shape. Compliance provided by the seal members or the surfaces themselves may allow an adequate seal to be formed even when the structures do not precisely conform.

Further, it is not necessary that the seals be mounted at the highest point of the surface of the chip socket. For example, if a chip 120 or circuit board 130 contains projecting members, housing 150 may contain channels or other recesses to receive those projecting members. In this configuration, the seals could be mounted to the surface of the housing, even though positioned at the bottom or the walls of the channel.

Furthermore, the drawings show connections to the chip socket being made through pads on the surface of a printed circuit board and a semiconductor chip. Connections are not so limited. Connections can be made to any structure that can be accessed from the surface, including conducting members that are positioned in recesses, cavities or holes within the surface.

Further, embodiments are described in which seals are formed around contact members by molding compliant material in place. The compliant material may be first formed in the desired shape and then positioned as desired.

As a further example, it was described that an advantage of an environmentally sealed chip package is that contact members may be designed to deliver reduced contact force. However, the motivation for incorporating the novel features described above is not a limitation on the invention. For example, the invention may be employed with contact members designed to provide contact forces comparable to those found in a traditional connector. Such a connector may be desirable for providing reliable connections in a harsh environment, such as one containing oxidizing gasses.

Further, it is described that chip socket 150 has symmetrical upper and lower surfaces. The compliant members need not be symmetrically disposed. For example, the pitch of the compliant members may be greater on the lower surface to facilitate manufacture of circuit board 130.

Further, it is not necessary that both sides of the chip socket include contact elements that make an electrical connection by being pressed against a mating contact element. For example, contact elements on the lower surface of chip socket 110 may be soldered to contacts on circuit board 130 or attached in any other suitable fashion. Also, the invention is described in connection with a chip socket style connector. The invention is not so limited. For example, the invention may be employed in connection with a pressure mount or press-fit electrical connector. Seals may be formed in the connector housing that is pressed into a printed circuit board. Alternatively, seals may be formed in a connector housing that is pressed against a housing of a mating connector, such as occurs in a backplane—daughter card connector assembly or a mezzanine connector assembly.

As an example of another variation, it is not necessary that the seals be formed as part of housing 150. Seals could be formed in or attached to chip 120 or circuit board 130.

Such alterations, modifications, and improvements are intended to be part of this disclosure, and are intended to be within the spirit and scope of the invention. Accordingly, the foregoing description and drawings are by way of example only.

What is claimed is:

1. An electrical connector, comprising:
a) a housing having a surface;
b) a plurality of conductive contact elements having a first portion and a second portion, with the first portion disposed in the housing and the second portion exposed in the surface;
c) a seal having a first portion and a second portion, with the first portion positioned in the housing and the second portion exposed in the surface, wherein the seal outlines an area of the surface and the second portion of at least one of the plurality of conductive contact elements is positioned within the area.

2. The electrical connector of claim 1, additionally comprising a plurality of seals, each of the plurality of seals outlining an area of the surface with at least one of the plurality of conductive contact elements positioned within each area.

3. The electrical connector of claim 1, wherein only one of the plurality of conductive contact elements is positioned within each area.

4. The electrical connector of claim 1, wherein the surface of the housing has a plurality of recesses formed therein.

5. The electrical connector of claim 4, wherein the second portion of each of the plurality of conductive contact elements comprises a compliant portion and each of the compliant portions is partially disposed in one of the plurality of recesses.

6. The electrical connector of claim 5, wherein the compliant portion of each of the plurality of conductive contact elements provides in excess of 0.2 mm of travel.

7. The electrical connector of claim 6, wherein the compliant portion of each of the plurality of conductive contact elements provides less than 30 grams of contact force.

8. The electrical connector of claim 1, wherein
a) the housing has a second surface;
b) each of the plurality of conductive contact elements has a third portion, with the third portion exposed in the second surface; and
c) the electrical connector additionally comprises a second seal having a first portion and a second portion, with the first portion positioned in the housing and the second portion exposed in the second surface, wherein the second seal outlines an area of the second surface and the third portion of at least one of the plurality of conductive contact elements is positioned within the area.

9. An electronic assembly using the electrical connector of claim 8, additionally comprising:
a) a printed circuit board having a surface and a plurality of conductive members, with the conductive members positioned to be accessible from the surface of the printed circuit board;
b) a semiconductor device having a surface and a plurality of conductive members, with the conductive members positioned to be accessible from the surface of the semiconductor device; and
c) wherein:
i) the second portion of each of the conductive contact elements contacts at least one of the plurality of conductive members of the printed circuit board and the second portion of the seal contacts the surface of the printed circuit board;
ii) the third portion of each of the conductive contact elements contacts at least one of the plurality of conductive members of the semiconductor device and the second portion of the second seal contacts the surface of the semiconductor device.

10. An electrical connector, comprising:
a) a housing having a surface;
b) a plurality of conductive contact elements having a first portion and a second portion, with the first portion disposed in the housing and the second portion exposed in the surface;
c) a plurality of compliant structures, each having a first portion and a second portion, with the first portion positioned in the housing and the second portion exposed in the surface, wherein each of the compliant structures outlines an area of the surface and the second portion of at least one of the plurality of conductive contact elements is positioned within the area.

11. The electrical connector of claim 10, wherein the housing comprises a plurality of recesses in the surface, each recess within one of the areas of the surface.

12. The electrical connector of claim 10, wherein the second portion of each of the plurality of conductive contact elements comprises a compliant contact portion, with each compliant contact portion disposed within one of the plurality of recesses.

13. The electrical connector of claim 10, configured as a chip socket.

14. The electrical connector of claim 13, wherein the surface of the housing is planar and the housing has a second surface, parallel to the surface, with the plurality of conductive contact elements each having a third portion, with the third portion exposed in the second surface.

15. The electrical connector of claim 14, wherein the housing comprises a plurality of channels in the housing, each of channels running between the surface and the second surface, and the first portion of each of the plurality of compliant structures is disposed in one of the plurality of channels and the second portion is exposed in the surface of the housing.

16. The electrical connector of claim 14, wherein the second portion and the third portion of each of the conductive contact elements comprises a curved portion.

17. The electrical connector of claim 16, additionally comprising an inert metal coating on the curved portion of each of the conductive contact elements.

18. A method of manufacturing an electrical connector, comprising:
a) providing a plurality of conductive members,
b) forming a housing of a first type material with a plurality of locations, each location adapted to receive a conductive member of the plurality of conductive members, the housing having a surface with at least a portion of each of the conductive members exposed through the surface; and
c) affixing a compliant member to the housing to encircle at least one of the locations, with a portion of the compliant member extending above the surface.

19. The method of manufacturing an electrical connector of claim 18, wherein:
a) forming a housing comprises forming a housing with a groove in the surface, the groove encircling at least one of the locations; and
b) affixing a compliant member to the housing comprises inserting a portion of the compliant member in the groove.

20. The method of manufacturing an electrical connector of claim 19, wherein affixing a compliant member comprises molding compliant material with a portion of the compliant material disposed in the groove and a portion of the compliant material extending from the groove.

21. The method of manufacturing an electrical connector of claim 20, wherein molding housing material comprises molding a thermoplastic material.

22. The method of manufacturing an electrical connector of claim 18, wherein forming the housing comprises molding housing material around the plurality of conductive members.

23. The method of manufacturing an electrical connector of claim 18, wherein forming a housing comprises forming a housing with a second surface, and affixing a compliant member to the housing comprises affixing a second compliant member to the housing to encircle at least one of the conductive members, with a portion of the second compliant member extending above the second surface.

24. The method of manufacturing an electrical connector of claim 18, wherein affixing a compliant member additionally comprises affixing a plurality of compliant members, each encircling at least one of the locations.
